(19) United States
(12) Patent Application Publication
(10) Pub. No.: US 2003/0127199 A1
(43) Pub. Date: Jul. 10, 2003

(54) Sun blind made of compound material

(75) Inventor: Dea-Ji Lou, Dong Guan City (CN)

Correspondence Address: BACON & THOMAS, PLLC, 625 SLATERS LANE, FOURTH FLOOR, ALEXANDRIA, VA, 22314

(73) Assignee: Wei rong dong Fuan Bamboo & Wood Products Co.Ltd., Guangdong (CN)

(21) Appl. No.: 10/035,235

(22) Filed: Jan. 4, 2002

(51) Int. Cl. E06B 3/12

(52) U.S. Cl. 160/236

(57) ABSTRACT

A sun blind leaf has two bamboo pieces, and at least one connecting piece alternately and securely arranged between the two bamboo pieces. Due to the heat and moisture resistance characteristic of the connecting plate, the sun blind leaf is durable and cheap.

### BACKGROUND OF THE INVENTION

1. Field of the Invention

The present invention relates to a sun blind, and more particularly to a sun blind made of compound materials. The sun blind is composed of leaves each made of two pieces of bamboo and two piece of battens each alternately arranged with one of the bamboo pieces. That is, the batten is sandwiched between the two bamboo pieces.

2. Description of Related Art

A conventional sun blind normally is made of plastic, which makes the sun blind cheap and easy to wash. While the living standard is escalating, people want more in their lives, especially quality in every item. Therefore, the existing sun blind no longer meets the requirement of the users. To meet the user's requirement, a kind of sun blind is introduced to the market. The sun blind is made of wood, which brings the original, rich wood smell indoors. Not only is the decoration purpose met, but also the living standard riches. However, having such a sun blind made of wood requires the consumption of large woods, which is bad for environment reservation. Moreover, the wooden sun blind is heavy and manufacture cost is high. In order to overcome the drawback, a bamboo made sun blind is invented. The bamboo made sun blind is light weight and resilient for making different shapes. However, due to the characteristics of bamboo, deformation is easy to occur especially in places where temperature changes dramatically. In order to have the sun blind durable, manufacturer has to spend a long period of time implementing large pressure to force bamboo plates together so as to ensure the adhesion between bamboo plates, which increases the manufacture cost. Furthermore, even under large pressure for a long period of time, the bamboo made sun blind is still vulnerable to moisture.

With reference to FIG. 5, the conventional bamboo made sun blind (6) as previously described is easily vulnerable to heat and moisture so that cracks (b) and deformations (a) are easily shown in this kind of sun blind (6).

To overcome the shortcomings, the present invention tends to provide an improved sun blind made of compound materials to mitigate and obviate the aforementioned problems.

### SUMMARY OF THE INVENTION

The primary objective of the present invention is to provide a sun blind made of at least two materials so that the resistance to moisture and deformation is enhanced and thus the sun blind is durable.

In order to accomplish the foregoing objective, the sun blind of the present invention has two pieces of bamboo and one batten sandwiched between the two pieces of bamboo. Because the batten is adjacent by two pieces of bamboo, the sensitivity of the sun blind to heat and moisture is reduced by the batten so that the sun blind has longer life span when compared with the conventional bamboo made sun blind.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the sun blind leaf before cutting;

FIG. 2 is a perspective view of the structure of each of the sun blind leaf of the present invention;

FIG. 3 is a perspective view of a second embodiment of the sun blind leaf before cutting;

FIG. 4 is a perspective view of the structure of each of the sun blind leaf in FIG. 3; and

FIG. 5 is a perspective view of a conventional sun blind leaf showing the deformation and cracks in the sun blind leaf.

### DETAILED DESCRIPTION OF THE PREFERRED EMBODIMENT

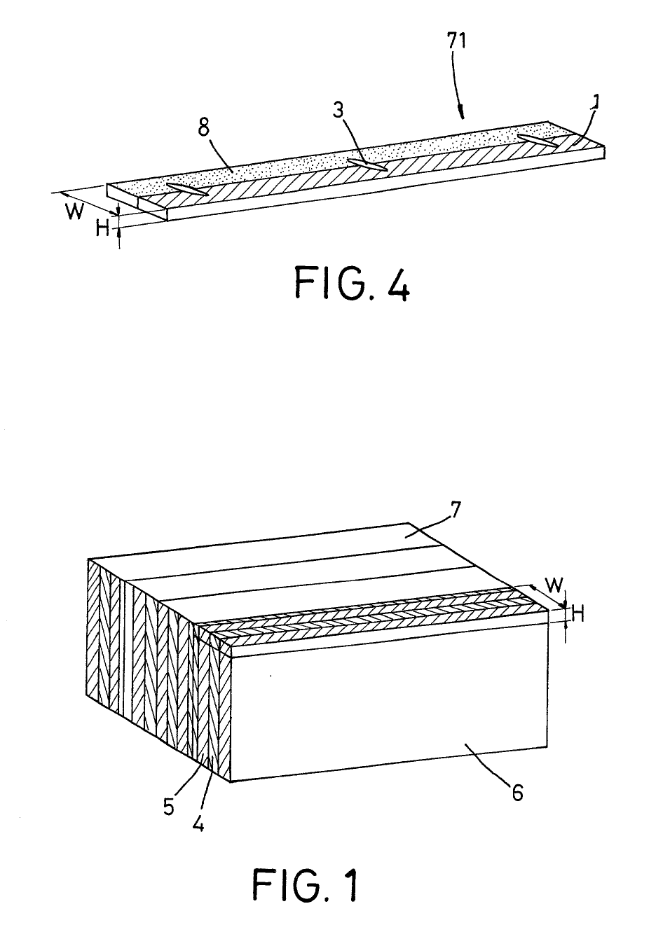

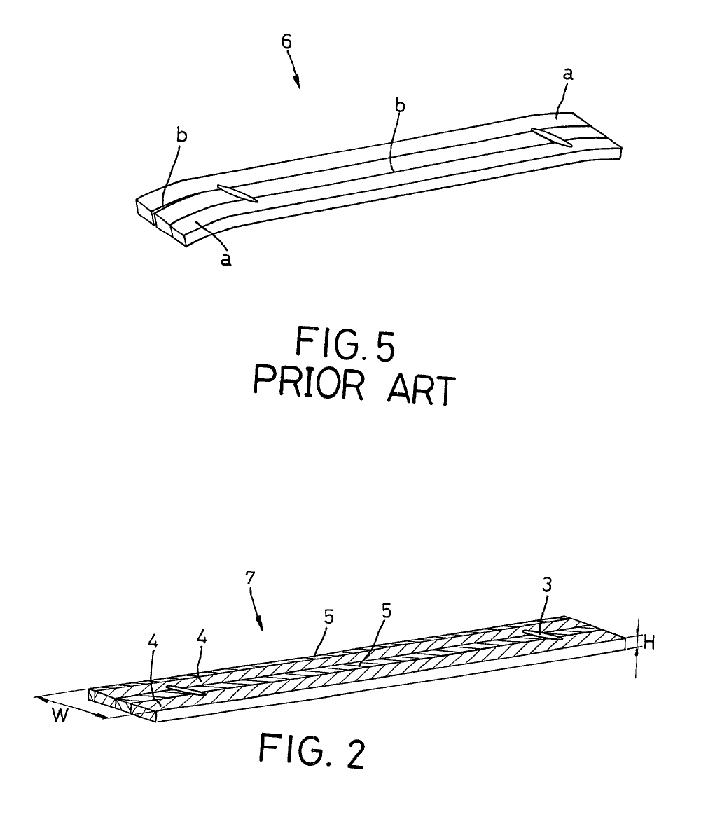

With reference to FIG. 1, it is to be noted first that the method of manufacturing the sun blind leaf is using a specially designed machine to cut a bamboo into pieces each having a substantially rectangular shape. The rectangular bamboo pieces are immersed in hydrogen peroxide and boiled for two hours to soften the bamboo tissue and strengthen the resilience. Then, the bamboo pieces are dried to remove excessive moisture. Therefore, the bamboo pieces are crafted to a predetermined size and then polished to become the required bamboo piece (4). Battens (5) each having the same size as the bamboo piece (4) are glued so as to combine with the bamboo piece (4). It is to be noted that when the combination of the bamboo pieces (4) and the battens (5), each of the battens (5) is arranged between two bamboo pieces (4). That is, the bamboo piece (4) and the batten (5) are alternately arranged with respect to each other to form a body (6). After the body (6) is formed, a leaf having a width W and height H is cut to form a sun blind leaf (7). Since the length of the sun blind leaf (7) is already determined when making the body (6), after the cut to the body (6), the manufacture of the sun blind leaf (7) of the present invention is completed. Two through holes (3) are defined in the sun blind leaf (7) to allow a string (not shown) to extend through the through holes (3) to combine the sun blind leafs (7) together, as shown in FIG. 2.

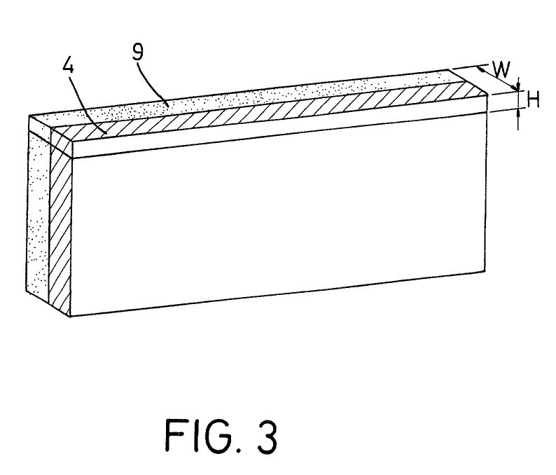

With reference to FIGS. 3 and 4, a second embodiment of the present invention is disclosed, wherein the manufacture process of the sun blind leaf (7′) is basically the same as described in the first embodiment. The difference lies on the fact that the batten (5) is changed to a fiber plate (9) which is combined with one bamboo piece (4) in stead of the alternate combination between two battens (5) and two bamboo pieces (4).

It is concluded that the present invention has the following advantages:

The deformation of the bamboo piece is limited by the wooden batten so that the sun blind leaf is durable.

Due to the resistance to heat and moisture of the connecting plate, only little pressure is necessary to combine the bamboo piece and the connecting piece, which dramatically reduce the manufacture cost.

The connecting piece may be made of wasted wood from all kind of different fields so that the product is economic and environment friendly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sun blind leaf comprising:
two bamboo pieces; and
at least one connecting piece alternately and securely arranged between the two bamboo pieces.

2. The sun blind leaf as claimed in claim 1, wherein the connecting piece is made of wood.

3. The sun blind leaf as claimed in claim 1, wherein the connecting piece is made of fiber.

4. The sun blind leaf as claimed in claim 2 further comprising two through holes defined through the sun blind leaf.

5. A sun blind leaf comprising:
a bamboo piece; and
a fiber plate securely arranged beside the bamboo piece.

6. The sun blind leaf as claimed in claim 5, wherein the connecting piece is made of fiber.

7. The sun blind leaf as claimed in claim 6 further comprising two through holes defined through the sun blind leaf.
